(19) United States
(12) Patent Application Publication
(10) Pub. No.: US 2009/0139611 A1
(43) Pub. Date: Jun. 4, 2009

(54) Galvanized Steel Sheet and Method for Producing the Same

(76) Inventors: Hideyuki Kimura, Fukuyama (JP); Yoshihiko Ono, Fukuyama (JP); Takeshi Fujita, Fukuyama (JP); Takayuki Futatsuka, Fukuyama (JP); Saiji Matsuoka, Fukuyama (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/084,173

(22) PCT Filed: Dec. 25, 2006
(86) PCT No.: PCT/JP2006/326320

§ 371 Date: Apr. 25, 2008

(30) Foreign Application Priority Data
Jan. 11, 2006 (JP) 2006-003137
Dec. 8, 2006 (JP) 2006-331782

(51) Int. Cl. C23C 2/02; C22C 38/04; C22C 38/38; B32B 15/01

(52) U.S. Cl. 148/533; 148/333; 148/516

(57) ABSTRACT

A galvanized steel sheet excellent in strength-ductility balance and bake-hardenability as well as a method for producing the same are provided. The chemical components thereof include C, Si, Mn, P, S, Al, N and Cr at content ratios of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.1 to 2.8, and further include iron and unavoidable impurities as the balance. The structure thereof consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary. In addition, in the production process of such a galvanized steel sheet, a steel sheet obtained in a cold rolling step is annealed at a temperature being at least the Ac1 point and not more than the Ac3 point.

### TECHNICAL FIELD

The present invention relates to galvanized steel sheets that are applicable in fields including automobiles and home appliances, have favorable press-formability and are excellent in terms of strength-ductility balance and bake-hardenability, as well as methods for producing such galvanized steel sheets.

### BACKGROUND ART

Recently, improvement in fuel efficiency of automobiles has been demanded from the perspective of global environment sustainability, and safety improvement of automobile bodies has also been desired from the perspective of protecting persons on board from accidental damage. To meet these demands, positive research for weight reduction of automobile bodies along with reinforcement, thereof has been conducted. It is said that enhancing the strength of materials of components is effective to meet these demands, weight reduction of automobile bodies along with reinforcement thereof. However, enhancement in the strength often leads to deterioration in formability, and thus not only improved strength but also excellent press-formability is necessary to produce steel sheets for automobiles requiring complicated forming.

Several approaches have thus been proposed to raise the strength of steel sheets while maintaining processability thereof. In a representative approach, large quantities of solid solution strengthening elements, Si and P, are added into interstitial free steel as a base material to achieve a tensile strength in the range of 340 to 490 MPa. For instance, Patent Document 1 discloses an example of methods for producing high-tensile stress steel sheets with a tensile strength of 490 MPa grade by adding P into Ti-containing extra-low-carbon steel.

Also investigated aiming high formability of steel sheets along with high strength thereof are dual-phase steel sheets, which are including a second hard phase, such as martensite or bainite, in the structure of ferrite main. For example, Patent Document 2 discloses a method for producing a steel sheet, wherein the structure of the steel sheet consists of ferrite and a second phase, recovery of the processed structure of ferrite is delayed by using a heating rate of at least 10° C./s for heating from 500 to 700° C. during heating to the annealing temperature, fine particles of ferrite measuring 2 to 6 μm in diameter are used to finely disperse the second hard phase to act as the starting points of fracture, and thereby the steel sheet acquires favorable strength-ductility balance of approximately 17000 MPa*%, the product of strength and ductility. Furthermore, Patent Documents 3 and 4 disclose methods for producing a steel sheet, wherein the structure of the steel sheet consists of ferrite and a second phase containing martensite, the rate of cooling after recrystallization is predetermined, the fraction of the second phase and the content ratio of martensite in the second phase are controlled, and thereby the steel sheet acquires a strength of 500 MPa or lower and favorable strength-ductility balance of approximately 17000 MPa*%.

Moreover, being developed as steel sheets achieving favorable press-formability along with post-forming high strength, steel sheets with bake-hardenability (hereinafter sometimes referred to as BH) are relatively soft and easily press-formed in press-forming, and then can be hardened by BH process to improve the strength as a component. These BH steel sheets are based on a hardening technique utilizing strain aging that occurs in the presence of C and N dispersed in steel. For example, Patent Document 5 discloses a steel sheet wherein solid C of approximately 30 ppm is dispersed in ferrite structure to fix dislocations, thereby enhancing bake-hardenability. Additionally, steel sheets described in Patent Document 5 are usually used as outer panels for automobiles. However, such steel sheets originally contain solid C at a small amount and thus BH is approximately in the range of 30 to 50 MPa at most. Also, extra-low-carbon steel used as a base material makes it difficult to improve the strength as a component to 440 MPa or higher. In response to this, research has been conducted on Dual Phase steel sheets wherein martensitic transformation induces dislocations in the mother phase, ferrite, and solid C dispersed in the ferrite fixes the dislocations, thereby improving BH. For example, Patent Document 6 discloses a method for producing a steel sheet, wherein steel contains Mn, Cr and Mo so that the total content ratio thereof (Mn+1.29Cr+3.29Mo), a index of BH, is in the range of 1.3 to 2.1%, the structure of the steel sheet contains at least 70% in volume fraction of ferrite and 1 to 15% in volume fraction of martensite, and thereby the steel sheet acquires a strength in the range of 440 to 640 MPa and BH equal to or higher than 60 MPa.

Patent Document 1: Japanese Examined Patent Application Publication No. S57-57945

Patent Document 2: Japanese Unexamined Patent Application Publication No. 2002-235145

Patent Document 3: Japanese Unexamined Patent Application Publication No. 2002-322537

Patent Document 4: Japanese Unexamined Patent Application Publication No. 2001-207237

Patent Document 5: Japanese Unexamined Patent Application Publication No. S59-31827

Patent Document 6: Japanese Unexamined Patent Application Publication No. 2006-233294

### DISCLOSURE OF INVENTION

However, the background arts described above have the following problems.

For example, techniques described in Patent Documents 1 and 5 involve solid solution hardening as an indispensable strengthening mechanism to enhance the strength. In the case of a strength being equal to or higher than 440 MPa, large quantities of Si and P should be added and thus issues deterioration of on the surface characteristics, such as difficulties in alloying, red scales or plating failures, are significant. It is therefore difficult to apply these techniques to outer panels of automobiles requiring stringent control of surface quality.

The technique described in Patent Document 2 uses ferrite particles with an average diameter being in the range of 2 to 6 μm, although reduction in the diameter of each ferrite particle leads to decreases in n value and uniform elongation. So this technique cannot be easily applied to outer panels of automobiles mainly formed by stretch forming, such as doors and hoods. Patent Documents 3 and 4 state that, in the techniques described therein, the primary cooling rate used in the production process thereof for cooling from the annealing temperature to the plating temperature is set in the range of 1 to 10° C./s so as to improve the content ratio of martensite in the second phase, and preferably it is set in the range of 1 to 3° C./s so as to reduce the volume fraction of the second phase to 10% or lower. However, for example, in the example where a primary cooling rate of 3° C./s is used for cooling from the annealing temperature of 800° C. to the plating temperature of 460° C., it takes approximately 113 seconds to complete the cooling step. This may affect the productivity. Moreover, the inventors actually cooled steel with Mn+1.3Cr of 2.15 at a primary cooling rate of 3° C./s according to the examples described in Patent Documents 3 and 4 (Sample 43, Examples, DESCRIPTION of Patent Document 3; Sample 29, Examples, DESCRIPTION of Patent Document 4), and evaluated the resulting microstructure. As a result, pearlitic or bainitic transformation progressed during the cooling step and it was difficult to achieve 90% or higher content ratio of martensite in the second phase consistently. This result indicates that steel sheets with excellent strength-ductility balance cannot be easily obtained by using the components and production methods described in Patent Document 3 or 4 because the ductility may be decreased as the result of pearlite or bainite generation in the second phase.

As for the techniques described in Patent Documents 2 to 4, the inventors actually prepared 0.6 to 0.8 mmt GA materials for panels according to the examples thereof and conducted a press test of the materials at the door model. As a result, portions like the vicinity of embossed areas, forming of which was rather difficult, cracked. In response to this, representative characteristics of the materials were measured and then TS was 443 MPa, El was 35.5%, and TS×El was 15727 MPa*%, suggesting that the strength-ductility balance was not so good. This may be due to the fact that the thickness of steel sheets used in the examples described in Patent Documents 2 to 4 was 1.2 mm and this large thickness probably contributed to the favorable balance between strength and ductility. Therefore, the inventors verified this assumption using Formula (2) derived from Oliver formula represented by Formula (1) (source: Puresu Seikei Nanni Handobukku (Handbook on Difficulties in Press-forming) 2nd Ed., P. 458, Usukouhan Seikei Gijutsu Kai), which is commonly used by those skilled in the art for evaluating ductility of thin steel sheets with different thicknesses.

El=λ(√A/L)^{m} (1)

In Formula (1), λ and m are material constants, and in general, m for iron is 0.4. The parameter A represents the cross-section area and L represents the gauge length.

El₂/El₁=(t₂/t₁)^{0.2} (2)

In Formula (2), El₁ and El₂ represent the elongation (%) where the sheet thickness is t₁ (mm) and t₂ (mm), respectively.

In this verification, the sheet thickness was assumed to be 0.75 mm, which is the thickness often used in the application of outer panels for automobiles, and the strength-ductility balance was not so good in any of the examples tested. More specifically, the example described in Patent Document 2 (Sample 35, Example, DESCRIPTION) exhibited TS of 446 MPa, El of 35.7% and TS×El of 15922 MPa*%, the example described in Patent Document 3 (Sample 43, Example, DESCRIPTION) exhibited TS of 441 MPa, El of 35.6% and TS×El of 15700 MPa*%, and the example described in Patent Document 4 (Sample 29, Example, DESCRIPTION) exhibited TS of 442 MPa, El of 35.5% and TS×El of 15691 MPa*%. In addition, considering press-formability, steel sheets having TS×El equal to or higher than 16000 MPa*% can be used in practical using without any problems, and TS×El is preferably 16500 MPa*% and more preferably 17000 MPa*%. Consequently, it is difficult to apply the technique described in Patent Documents 2 to 4 to outer panels of automobiles, such as doors and hoods.

Furthermore, in the technique described in Patent Document 6, a second cooling rate is conducted under the conditions where the cooling rate is 100° C./s or higher and the cooling stop temperature is 200° C. or lower, for the purpose of controlling the martensite volume fraction and the quantity of dispersed solid C in ferrite as well as ensuring high BH. However, these cooling conditions can be satisfied only in an extraordinary method like water jet described in Patent Document 6, so that, in practice, the industrial manufacturing using this technique is difficult. In addition, Patent Document 6 discusses only formability with reference to the results of a cylinder-forming test, omitting descriptions of ductility-related parameters such as total elongation, uniform elongation and local elongation. Therefore, steel sheets obtained using this technique may be insufficient in terms of the strength-ductility balance, and thus cannot be easily applied to outer panels of automobiles, such as doors and hoods.

The present invention was made to solve these problems and provides a galvanized steel sheet having a tensile strength in the range of 340 to 590 MPa, TS×El being equal to or higher than 16000 MPa*% considering press-formability, and the yield stress difference between a value measured after the application of 2% prestrain and a value measured after subsequent bake-hardening by heating at 170° C. for 20 minutes being equal to or higher than 50 MPa, in other words, a galvanized steel sheet that has high formability and is excellent in strength-ductility balance and bake-hardenability, as well as a method for producing the same.

To solve the problems described above, the inventors focused on a dual-phase steel consisting of a ferrite phase and a martensite phase. As a result, the following findings were obtained.

First, transformation strengthening is utilized as a strengthening mechanism and the volume fraction of the martensite phase is reduced as much as possible, and thereby the strength range of 340 to 590 MPa, which was difficult to achieve using interstitial free steel as a base material, is obtained.

Furthermore, the particle diameter of ferrite and the position of the martensite phase are controlled so as to enhance the deformability of ferrite, and thereby the uniform elongation is improved.

Moreover, the second phase is uniformly dispersed to improve local elongation, and thus a galvanized steel sheet having excellent balance between strength and ductility can be obtained.

Additionally, the content ratio of Mn and Cr, a index of bake-hardenability, is appropriately controlled so as to obtain high BH.

The present invention was made based on these findings, and is summarized as follows.

[1] A galvanized steel sheet that contains C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.1 to 2.8, and contains iron and unavoidable impurities as the balance, wherein the structure thereof consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

[2] A galvanized steel sheet that contains C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.2 to 2.8, and contains iron and unavoidable impurities as the balance, wherein the structure thereof consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

[3] A galvanized steel sheet that contains C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.3 to 2.8, and contains iron and unavoidable impurities as the balance, wherein the structure thereof consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

[4] A galvanized steel sheet that contains C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.35 to 0.8%, respectively, with Mn (mass %)+1.29Cr (mass %) being in the range of 2.3 to 2.8, and contains iron and unavoidable impurities as the balance, wherein the structure thereof consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

[5] The galvanized steel sheet according to any one of [1] to [4] described above, further containing one or more of Mo, V, B, Ti and Nb at content ratios in mass % of 0.5% or lower, 0.5% or lower, 0.01% or lower, 0.1% or lower and 0.1% or lower, respectively.

[6] The galvanized steel sheet according to any one of [1] to [5] described above, wherein zinc used to plate the steel sheet is alloyed.

[7] A method for producing a galvanized steel sheet including a step of melting steel having the chemical composition described in any one of [1] to [5] above, subsequent hot and cold rolling steps, and a step of annealing the obtained steel sheet at an annealing temperature being at least the Ac1 point and not more than the Ac3 point.

[8] A method for producing a galvanized steel sheet including a cold rolling step for rolling a hot-rolled steel sheet that has the chemical composition described in any one of [1] to [5] above and further contains a low-temperature transformation phase at a volume fraction of 60% or higher, and a step of annealing the obtained steel sheet at an annealing temperature being at least the Ac1 point and not more than the Ac3 point.

[9] The method for producing a galvanized steel sheet according to [7] or [8] described above, wherein zinc used to plate the steel sheet is alloyed after galvanization.

In addition, percentages representing components contained in steel in this description are all mass percentages.

The present invention provides a galvanized steel sheet excellent in strength-ductility balance and bake-hardenability by appropriately controlling the content ratio of Mn and Cr, the average particle diameter of ferrite, and the position, distribution profile and volume fraction of a martensite phase. Furthermore, galvanized steel sheets according to the present invention have such excellent characteristics and are applicable in fields of home appliance, steel sheets for automobiles and others, thus being beneficial to industry.

### BRIEF DESCRIPTION OF THE DRAWINGS

FIG. 1 is a diagram that shows the relationship between the content of Mn and Cr and TS×El.

FIG. 2 is a diagram that shows the relationship between the content ratio of Mn and Cr and the bake-hardenability (BH).

### BEST MODE FOR CARRYING OUT THE INVENTION

The present invention is explained in detail below.

First, the reason why the chemical composition of steel is limited as described above in the present invention is stated.

### C: 0.005 to 0.04%

In the present invention, C is one of very important elements and is highly effective in forming a martensite phase to enhance the strength. However, a content of C exceeding 0.04% would lead to significant deterioration in formability and decreases in weldability. Therefore, the content of C should not exceed 0.04%. On the other hand, the martensite phase is required to account for at least a volume fraction needed to ensure the strength and high BH, and therefore C should be contained to some extent. Consequently, the content of C should be at least 0.005%, and preferably higher than 0.010%.

### Si: 1.5% or Lower

Si is an element effective in raising the strength and consistently producing a composite structure. However, a content of Si exceeding 1.5% would lead to significant deterioration in surface characteristics and phosphatability. Therefore, the content of Si should be 1.5% or lower, and preferably 1.0% or lower.

### Mn: 1.0 to 2.0%

Mn is one of important elements used in the present invention. Mn has a very important role in the formation of a martensite phase and an ability to improve BH, and acts to prevent slabs from cracking during a hot rolling step because of the grain boundary-embrittling effect of S by fixing S contained in steel in the form of MnS. Therefore, the content of Mn should be at least 1.0%. However, a content of Mn exceeding 2.0% would lead to significant increases in the cost for slabs, and adding a large quantity of Mn would promote the formation of band-shaped structures, thereby deteriorating the formability. Therefore, the content ratio of Mn should not exceed 2.0%.

P: 0.10% or lower

P is an element effective in raising the strength.

However, a content of P exceeding 0.10% would lead to decreases in the alloying rate of a zinc coating layer, thereby causing insufficient plating or a failure of plating, and resistance to secondary working embrittlement of a steel sheet. Therefore, the content of P should not exceed 0.1%.

### S: 0.03% or Power

S deteriorates the hot formability and raises the susceptibility of slabs to cracks due to heating, and fine precipitation of MnS that form when the content ratio of S exceeds 0.03% degrade the formability. Therefore, the content of S should not exceed 0.03%.

### Al: 0.01 to 0.1%.

Al is a deoxidizing element having the effect of removing inclusions in steel. However, Al contained at a content less than 0.01% cannot provide this effect consistently. On the other hand, a content of Al exceeding 0.1% would result in the increased amount of alumina inclusion clusters, which affect formability. Consequently, the content of Al should be in the range of 0.01 to 0.1%.

N: less than 0.008%

To improve the processability and aging characteristics, the lower the content of N is better. A content ratio of N being equal to or higher than 0.008% would result in the formation of an excessive amount of nitrides, thereby degrading the ductility and strength. Therefore, the content of N should be less than 0.008%.

### Cr: 0.2 to 1.0%

Cr is one of important elements used in the present invention. Cr is an element that improves BH and is added to form a stable martensite phase. It improves BH more effectively than Mn and helps a martensite phase exist in a grain boundary, and thus is an element advantageous to the structure formation according to the present invention. Furthermore, in the present invention, Cr is an indispensable element since it strengthens solid solutions to only a slight extent and is suitable for low-strength DP steel, and thus is added at a content of 0.2% or more, preferably 0.35% or more, and more preferably more than 0.5%, so as to achieve these advantageous effects. However, a content of Cr exceeding 1.0% would result in not only the saturation of such advantageous effects but also deterioration the ductility due to the formation of carbides. Consequently, the content ratio of Cr should be in the range of 0.2 to 1.0%, and preferably 0.35 to 0.8% to ensure the sufficient strength and ductility.

### Content Ratio of Mn and Cr: Mn (Mass %)+1.29Cr (Mass %) in the Range of 2.1 to 2.8

Mn and Cr are elements that improve BH, and it is extremely important to control them to the optimum content ratios for the formation of a martensite phase. A total content ratio of Mn and Cr being less than 2.1% would result in difficulties in the formation of a DP structure and make it impossible to achieve desired BH, thereby leading to decrease in the strength as a component. Furthermore, an increased yield ratio makes it difficult to carry out a press-forming step and causes defective shape. Also, pearlite and bainite would be likely to form in a cooling step following a crystallization annealing step, thereby reducing BH. On the other hand, a weighted total content ratio of Mn and Cr exceeding 2.8% would result in not only the saturation of the advantageous effects described above but also decreases in formability because of residual martensite in ferrite particles increasing with the rise of the martensite volume fraction. Moreover, increases in the yield point associated with the rise of strength also reduce the press-formability significantly, and cause the rise of manufacturing cost by necessitating the addition of excessive amounts of alloy elements. Consequently, the weighted content ratio of Mn and Cr, Mn+1.29Cr, should be in the range of 2.1 to 2.8%. To achieve high BH, the lower limit thereof is preferably 2.2%, and more preferably 2.3%. Also, to ensure favorable formability, the upper limit thereof is preferably 2.6%.

The above-mentioned essential elements provide steel according to the present invention with desired characteristics, but one or more of the following elements may be added in addition to the above-mentioned essential elements, as needed:

Mo (0.5% or Lower), V (0.5% or Lower), B (0.01% or Lower), Ti (0.1% or lower) and Nb (0.1% or Lower). Mo: 0.5% or Lower, V: 0.5% or Lower

Mo and V are elements that each improve BH, and may be added to form a stable martensite phase. However, content of Mo and/or V exceeding 0.5% each would reduce the ductility and increase the cost. Therefore, the content of Mo and/or V should not exceed 0.5% each, if applicable.

### B: 0.01% or Lower

B is an element effective in improving BH, and may be added to form a stable martensite phase. However, a content ratio of B exceeding 0.01% would not provide an effect worth the cost. Therefore, the content of B should not exceed 0.01%, if applicable.

### Ti: 0.1% or Lower, Nb: 0.1% or Lower

Ti and Nb are elements that effectively improve the deep-drawing characteristics by decreasing the quantities of dispersed solid C and N through the formation of carbonitrides. However, content of Ti and/or Nb exceeding 0.1% each would result in the saturation of such an advantageous effect and the rise of the recrystallization temperature for annealing, thereby deteriorating the productivity. Therefore, the content of Ti and/or Nb should not exceed 0.1% each, if applicable.

In addition, the chemical components excluding the above-described elements are Fe and unavoidable impurities. As an example of such unavoidable impurities, 0 forms nonmetal inclusions affecting the product quality, so it is preferably removed so as to account for a content of 0.003% or lower.

Next, the structure of the galvanized steel sheet according to the present invention is described below.

The galvanized steel sheet according to the present invention consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary. These are essential requirements of the present invention and a structure satisfying these requirements would provide a galvanized steel sheet with excellent strength-ductility balance according to the present invention.

Volume Fraction of the Martensite Phase: at Least 3.0% and Less than 10%

A two-phase structure consisting of a ferrite phase and a martensite phase with a volume fraction being at least 3.0% and less than 10% constitutes the galvanized steel sheet according to the present invention. A volume fraction of the martensite phase being 10% or higher would make a steel sheet for outer panels of automobiles, an intended product of the present invention, insufficient in the press-formability. Therefore, the volume fraction of the martensite phase should not exceed 10% and, to ensure sufficient formability, the volume fraction of the martensite phase is preferably less than 8%. On the other hand, a volume fraction of the martensite phase being less than 3.0% would cause the mobile dislocation density, introduced with transformation, to be insufficient, thereby decreasing BH and reducing the dent resistance. Furthermore, it increases YP and makes YPEl more likely to remain, hereby decreasing the press-formability and the surface regularity of obtained panels, respectively. Therefore, the volume fraction of the martensite phase should be at least 3.0%.

In addition, the steel sheet according to the present invention may contain a pearlite phase, a bainite phase, a residual γ phase and unavoidable carbides to the maximum extent of approximately 3% besides the above-mentioned two phases, ferrite and martensite phases. However, a pearlite or bainite phase formed near the martensite phase would often provide the origins of voids and promote the growth of such voids. Therefore, to ensure sufficient formability, such a pearlite phase, a bainite phase, a residual γ phase and unavoidable carbides are contained preferably at less than 1.5%, and more preferably at 1.0% or less.

Average Particle Diameter of Ferrite: Larger than 6 μm and not More than 15 μm

The smaller the particle diameters of crystals are, the more reduced n value and uniform elongation contributing to the stretch-formability are. In the case where the average particle diameter of ferrite is 6 μm or lower, the decrease in n value and uniform elongation is more significant. However, an average particle diameter of ferrite exceeding 15 μm would cause the surface roughness to be introduced during a press-forming step and deteriorate the surface characteristics, and thus is not recommended. Consequently, the average particle diameter of ferrite should be larger than 6 μm, and not exceed 15 μm.

### Position of the Martensite Phase: 90% in the Ferrite Grain Boundary

The position of the martensite phase is a very important factor of the present invention and is an essential requirement of the advantageous effects of the present invention. A martensite phase existing in a ferrite particle reduces the deformability of the ferrite, and a percentage of such a martensite phase in a ferrite particle being 10% or higher would make this tendency stronger. Therefore, to achieve excellent strength-ductility balance intended by the present invention, 90% or more of the martensite phase should be in the ferrite grain boundary. In addition, to further improve the strength-ductility balance, it is preferable that 95% or more of the martensite phase exists in the ferrite grain boundary.

Next, manufacturing conditions for the galvanized steel sheet according to the present invention, which is excellent in the strength-ductility balance and BH, are explained.

The galvanized steel sheet according to the present invention is produced by melting steel the content ratios of whose chemical components are adjusted so as to fall within the ranges described above, rolling the steel in hot and subsequent cold rolling steps, and annealing the obtained steel sheet at an annealing temperature being at least the Ac1 point and not more than the Ac3 point. In the cold rolling step, the hot-rolled steel sheet preferably contains a low-temperature transformation phase at a volume fraction of 60% or higher.

Furthermore, it is more preferable that, during a galvanization step following the annealing step, the galvanized steel sheet according to the present invention is subjected to recrystallization annealing at an annealing temperature being at least the Ac1 point and not more than the Ac3 point, primary cooling from the annealing temperature to a galvanization temperature with an average cooling rate exceeding 3° C./s and being not more than 15° C./s, and then secondary cooling with an average cooling rate being not less than 5° C./s. The step of alloying the plating may be added after the galvanization step. Such a process of galvanizing annealed steel sheets can be carried out using a continuous galvanization line.

Preferred conditions and manufacturing conditions of the structure of the hot-rolled steel sheet are described in detail below.

### Structure of a Hot-Rolled Steel Sheet: Low-Temperature Transformation Phase Having a Volume Fraction of 60% or More (Preferred Range)

In the above-mentioned process, the hot-rolled steel sheet obtained in the hot rolling step preferably has a structure containing a low-temperature transformation phase at a volume fraction of 60% or higher. A known hot-rolled steel sheet having a structure that consists of ferrite and pearlite phases would be likely to hold insoluble carbides while α+γ biphasic regions are being annealed. This problem and uneven distribution of the pearlite phase in the hot-rolled steel sheet result in uneven distribution of large γ phases. As a result, a structure consisting of rather large and unevenly distributed martensite phases is formed. On the other hand, in the case of a hot-rolled steel sheet containing a low-temperature transformation phase at a volume fraction of 60% or higher, such as the hot-rolled steel sheet according to the present invention, fine carbides are dissolved once in a ferrite phase during a heating stage of an annealing step, and then uniform and fine γ phases are generated from the ferrite grain boundary while α+γ biphasic regions are being annealed. As a result, uniform distribution of the martensite phase in the ferrite grain boundary, which is intended by the present invention, is achieved and local elongation is improved. In addition, such a low-temperature transformation phase contained in the hot-rolled steel sheet is an acicular ferrite phase, a bainitic ferrite phase, a bainite phase, a martensite phase or a mixed phase thereof. Meanwhile, a hot-rolled steel sheet containing a low-temperature transformation phase at a volume fraction of 60% or higher can be obtained by suppressing the transformation or growth of ferrite that occurs after a finish rolling step. For example, it can be obtained by cooling the steel sheet at a cooling rate of 50° C./s or higher after a finish rolling step to suppress the transformation of ferrite and then taking up the steel sheet at a temperature of 600° C. or lower. More preferably, the taking-up temperature is less than 550° C. Heating rate: less than 10° C./s for the temperature range from the Ac1 transformation point, −50° C., to the annealing temperature (preferred range)

The heating rate for recrystallization annealing is not particularly limited. However, to facilitate the production of the steel sheet structure (with the preferred average particle diameter of ferrite and the preferred position of the martensite phase) intended by the present invention, it is preferable that recrystallization is fully completed before the temperature exceeds the Ac1 transformation point. Therefore, for example, the heating rate for the temperature range from the Ac1 transformation point, −50° C., to the annealing temperature is preferably less than 10° C./s. In addition, at temperatures lower than this temperature range, the heating rate does not always have to be lower than 10° C./s and may be much higher. Of course, a hot-rolled steel sheet containing a low-temperature transformation phase at a volume fraction of 60% or higher would provide the structure according to the present invention more efficiently.

Annealing temperature: at least the Ac1 point and not more than the Ac3 point

To obtain a microstructure consisting of ferrite and martensite phases, the annealing temperature should be adequately high. If an annealing temperature is less than the Ac1 point, no austenite phase forms and accordingly no martensite phase forms. In such a situation, the particle diameter of ferrite is so small that the press-formability is reduced in association with decreases in n value and uniform elongation. On the other hand, an annealing temperature exceeding the Ac3 point would result in that the ferrite phase is fully austenitized, thereby deteriorating characteristics such as formability obtained by recrystallization. The particle diameter of ferrite is so large in this situation that surface characteristics are also worsened. Furthermore, C is contained at a low content ratio in the steel according to the present invention, so that annealing at a high temperature would result in insufficient concentration of C in the γ phase. This makes it difficult to form a DP structure and accordingly reduces the strength and BH. Furthermore, even if a DP structure is formed by raising quenching characteristic to a sufficient level, a large amount of martensite precipitates in the particles and thus the ductility is deteriorated. Consequently, the annealing temperature should be at least the Ac1 point and not exceed the Ac3 point. To ensure sufficient formability, the annealing temperature is preferably at least the Ac1 point and not more than a temperature 100° C. higher than the Ac1 point. As for the annealing time, to achieve a favorable average particle diameter of ferrite and promote the concentration of component elements in an austenite phase, the duration thereof is preferably at least 15 seconds and shorter than 60 seconds. In addition, the Ac1 and Ac3 points may be determined by actual measurement or calculated using the following formula (“Leslie Tekkou Zairyou Gaku” (The Physical Metallurgy of Steels), P. 273, MARUZEN Co., Ltd.):

Ac1=723−10.7Mn+29.1Si+16.9Cr

Ac3=910−203Ĉ0.5+44.7Si+104V+31.5Mo−30Mn−11Cr+700P+400Al+400Ti

Primary cooling rate: higher than 3° C./s and not more than 15° C./s (preferred range)

In the production process of the galvanized steel sheet, the primary cooling rate for cooling from the annealing temperature to the galvanization temperature is not particularly limited. However, to form martensite, the average cooling rate is preferably higher than 3° C./s and not more than 15° C./s. The cooling rate exceeding 3° C./s would prevent austenite from transforming into pearlite in the cooling step, thereby helping a martensite phase intended by the present invention form. This improves the strength-ductility balance and BH. On the other hand, the cooling rate is preferably 15° C./s or lower because in this range the steel sheet structure intended by the present invention can be consistently formed extending in both lateral direction and longitudinal direction (running direction) of a steel sheet. Therefore, the average cooling rate for cooling from the annealing temperature to the galvanization temperature is preferably higher than 3° C./s and not more than 15° C./s, and a more effective average cooling rate is in the range of 5 to 15° C./s. In addition, the galvanization temperature is in the normal range, i.e., approximately in the range of 400 to 480° C.

Secondary cooling rate: 5° C./s or higher (preferred range)

The secondary cooling rate after the galvanization step or the additional step of alloying the plating layer is not particularly limited. However, the cooling rate being 5° C./s or higher would prevent austenite from transforming into pearlite or other phases, thereby helping a martensite phase form. Therefore, the secondary cooling rate is preferably 5° C./s or higher. On the other hand, the upper limit of the second cooling rate is not particularly limited as well, although it is preferably less than 100° C./s for such purposes as preventing the deformation of the steel sheets. In addition, the plating layer is alloyed by continuously heating it typically at a temperature approximately in the range of 500 to 700° C., and preferably approximately in the range of 550 to 600° C., for a few seconds to several tens of seconds.

Conditions not described above are as follows. A method for melting steel is not particularly limited, and examples of such a method may include an electric furnace, a converter or the like. Also, a method for casting molten steel may be continuous casting to form cast slabs or ingot casting to form steel ingots. Continuously cast slabs may be reheated using a heating furnace before being hot-rolled or directly sent to the hot rolling step. Steel ingots may be rough rolling before being hot-rolled. The finish temperature of hot-rolling is preferably the Ar3 point or higher. The cold-rolling ratio is in the range of 50 to 85% of the value used in normal operations.

As for galvanization conditions, the plating weight is preferably in the range of 20 to 70 g/m², and Fe % in a plating layer is preferably in the range of 6 to 15%.

In addition, the present invention may include the step of temper-rolling steel sheets according to the present invention to reform the steel sheets after a heat treatment step. Also, in the present invention, it is intended that steel materials are subjected to ordinary steelmaking, casting and hot-rolling steps to produce steel sheets. However, the hot-rolling step may be partly or completely omitted, for example, with the use of thin slab casting.

Of course, electrogalvanization of steel sheets obtained in the above-mentioned processes also provides the intended advantageous effects. Such electrogalvanized steel sheets may be coated with an organic layer thereafter.

### EXAMPLES

The present invention is described in more detail below with reference to examples.

Steels A to Y each having a distinct chemical composition listed in Table 1 were molten by vacuum melting and then shaped into slabs by continuous casting. Steels A to S are examples of the present invention. As comparative examples, each of Steels T and U has the content of C deviating from its range according to the present invention, each of Steels V, X and Y has the content ratio of Mn and Cr deviating from its range according to the present invention, and Steel W has the contents of Mn and Cr each deviating from the range according to the present invention.

Each of the slabs obtained in the above-mentioned steps was heated at 1200° C., subjected to finish rolling at a temperature equal to or higher than the Ar3 point, cooled in water, and then taken up at a temperature exceeding 500° C. and being less than 650° C. In this way, hot-rolled steel sheets having volume fractions of a low-temperature transformation phase varying in the range of 5 to 100% were produced.

Each of these hot-rolled steel sheets was pickled and then subjected to cold rolling at a rolling ratio of 75%, so that cold-rolled steel sheets each having a thickness of 0.75 mm were obtained.

In an infrared furnace, samples cut out of these cold-rolled steel sheets were each heated from the Ac1 transformation point, −50° C., to the annealing temperature at a heating rate in the range of 5 to 20° C./s as shown in Table 2, maintained at the annealing temperature indicated in Table 2 for 30 seconds, cooled at a primary cooling rate in the range of 3 to 20° C./s, and then galvanized in a plating bath adjusted to 460° C. Thereafter, the samples were each alloyed at 550° C. for 15 seconds, and then cooled at a secondary cooling rate in the range of 4 to 20° C./s. In this way, alloyed galvanized steel sheets were obtained.

Subsequently, samples were taken from these alloyed galvanized steel sheets. These samples were evaluated for the average particle diameter of ferrite, the volume fraction of a martensite phase, the volume fraction of a second phase excluding the martensite phase and the percentage of the martensite phase in the grain boundary, and mechanical properties and BH thereof were measured as performance characteristics.

Each sample was cut in the direction of thickness at the middle thereof, and then, in accordance with the method described in JIS G 0552, the average particle diameter of ferrite of each sample was measured using an optical microscope image (with a magnitude of 400) showing the structure of the section.

The section of each cut sample was polished and corroded with nital, and then the volume fraction of a martensite phase, the volume fraction of a second phase excluding the martensite phase and the percentage of the martensite phase in the grain boundary were measured using an SEM (scanning electron microscope) image of the microstructure of the section. It should be noted that, in these measurement steps, fields within the central area of the section, each having a size of 100 μm in length and 200 μm in width, were continuously imaged with a magnitude of 2000 and then the average values of the above-mentioned parameters were calculated from the obtained images.

As mechanical properties, the YP (yield point), TS (tensile strength), T-El (total elongation), U-El (uniform elongation) and L-El (local elongation) of JIS-5 test pieces taken from the samples were measured in a tensile test according to the test method specified in JIS Z 2241.

BH of each sample was also measured using JIS-5 test pieces taken from the samples in accordance with the method specified in JIS G 3135, where the increase in the yield point was measured as BH the tensile test performed after the application of 2% prestrain and subsequent heating at 170° C. for 20 minutes.

In the present invention, TS×El should be 16000 MPa*% or higher, and it is preferably 16500 MPa*% or higher and more preferably 17000 MPa*% or higher. On the other hand, BH should be 50 MPa or higher, and it is preferably 55 MPa or higher and more preferably 60 MPa or higher. This lower limit of BH is the value necessary to achieve the dent resistance required in the process of making steel sheets for automobile outer panels thinner and lighter.

The results of the above-mentioned tests and the manufacturing conditions used are listed in Table 2.

In Table 2, Samples 1, 4, 5, 7 to 13, 15, 17 to 35, 37 and 38 are the examples of the present invention, each of which has the chemical composition and the manufacturing conditions according to the present invention, and has a structure where the volume fraction of a martensite phase is at least 3.0% and less than 10%, the average particle diameter of ferrite exceeds 6 μm and is not more than 15 μm, and 90% or more of the martensite phase in the ferrite grain boundary. These examples of the present invention exhibited TS×El of at least 16000 MPa*% and BH of at least 50 MPa, thereby demonstrating that the obtained galvanized steel sheets are excellent in the strength-ductility balance and BH.

On the other hand, as comparative examples, each of Samples 39 and 40 has the content of C deviating from its range according to the present invention, each of Samples 41, 43 and 44 has the content ratio of Mn and Cr deviating from its range according to the present invention, and Sample 42 has the contents of Mn and Cr each deviating from the range according to the present invention. Also, each of the other comparative examples, Samples 2, 3, 6, 14, 16 and 36, was annealed at a temperature deviating from the range of annealing temperature according to the present invention, and in these samples, at least one of the volume fraction of a martensite phase, the average particle diameter of ferrite and the percentage of the martensite phase in the ferrite grain boundary are out of the corresponding range according to the present invention. Each comparative example exhibited substandard TS×El and BH values, and thus these comparative examples are considered insufficient in the press-formability and difficult to make thinner than existing steel sheets.

Furthermore, comparison between or among the examples of the present invention having the same chemical composition and different structures of the hot-rolled sheet, i.e., comparison between Samples 1 and 4, 5 and 7, 10 and 11, and among Samples 25 to 27, suggested that Samples 1, 5, 7, 10, 25 and 26, in which the content ratio of a low-temperature transformation phase in the structure of the hot-rolled steel sheet is in the preferred range, 60% or higher, is better in terms of the strength-ductility balance than Samples 4, 11 and 27. Moreover, under the same chemical composition, comparison between Samples 5 and 9, and 10 and 12 heated at different heating rates, comparison between Samples 5 and 8, and 32 and 35 annealed at different temperatures, comparison among Samples 32 to 34 cooled at different primary cooling rates, and comparison among Samples 25, 28 and 29 cooled at different secondary cooling rates were made. As a result, Samples 7 and 10 each heated at a heating rate in the preferred range, less than 10° C./s, Samples 5 and 32 each annealed at a temperature in the preferred range, not more than 100° C. higher than the Ac₁ point, Sample 32 cooled at a primary cooling rate in the preferred range, higher than 3° C./s and not more than 15° C./s, Samples 25 and 29 each cooled at a secondary cooling rate in the preferred range, 5° C./s or higher, were better in terms of the strength-ductility balance than Samples 9, 12, 8, 35, 33, 34 and 28.

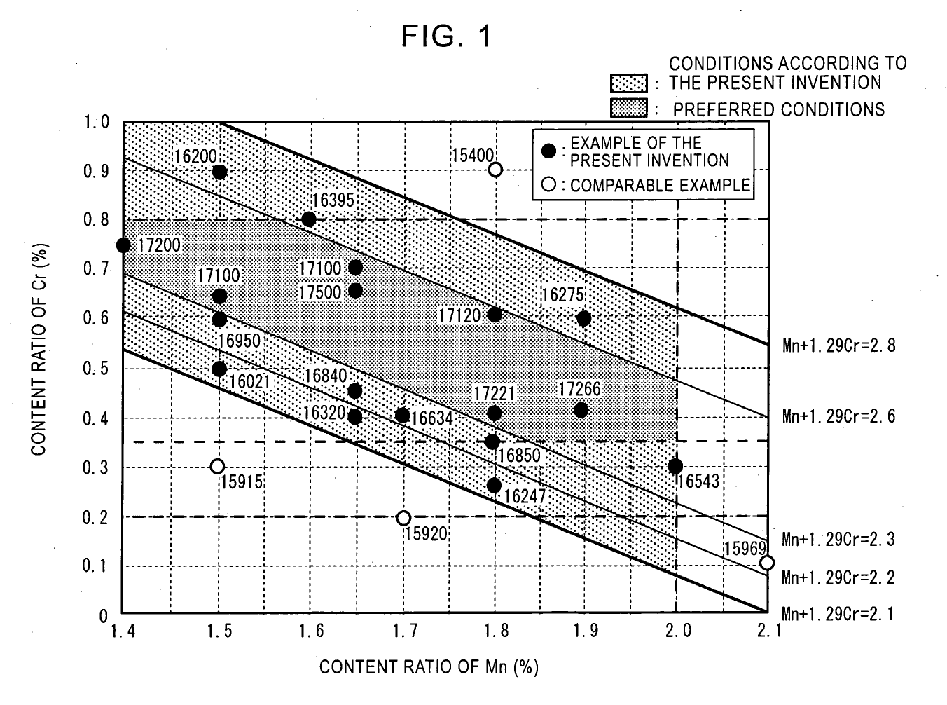

Excluding Samples 39 and 40 whose content of C deviates from the range according to the present invention, FIG. 1 shows the summary of relationship among the content ratios of Mn and Cr and the TS×El values for Samples 1, 5, 10, 13, 15, 17 to 25, 30 to 32, 37, 38 and 41 to 44 based on the results listed in Table 2. These examples of the present invention and comparative examples each have a low-temperature transformation phase in the structure of the hot-rolled steel sheet at a percentage of 100% and contain Mn and Cr at different content ratios, and the heating temperature, annealing temperature, primary cooling rate and secondary cooling rate of these samples were in the preferred ranges according to the present invention. As seen in FIG. 1, TS×El was higher than 16000 MPa*% for all the examples of the present invention, and higher than 16500 MPa*% for the examples under the preferred conditions, i.e., examples containing Mn and Cr at a content ratio in the range of 2.2 to 2.6%, confirming the favorable strength-ductility balance. This drawing also shows that the examples under the more preferred conditions, i.e., samples in which the content of Cr was in the range of 0.35 to 0.8% and the content ratio of Mn and Cr was in the range of 2.3 to 2.6%, had TS×El being 17000 MPa*% or higher, thereby suggesting that these conditions resulted in more favorable strength-ductility balance than the other conditions.

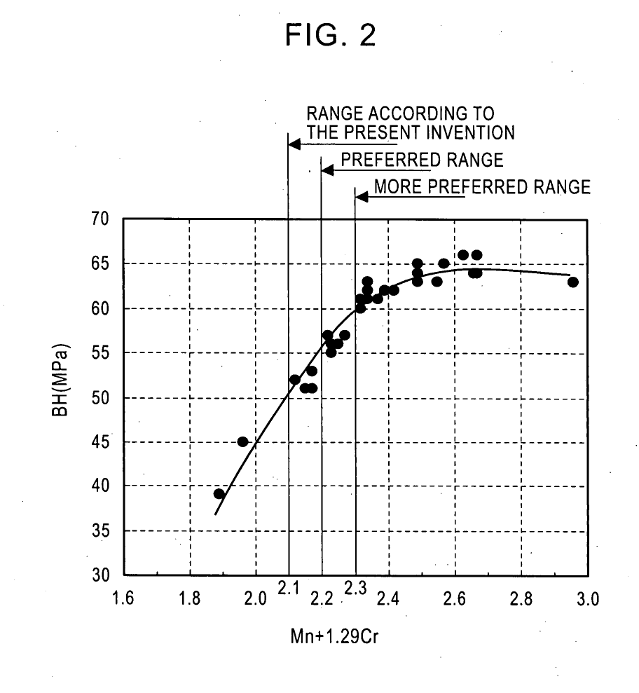

FIG. 2 shows the summary of relationship between the content ratio of Mn and Cr and the BH of the above-mentioned steel samples. As is obvious in FIG. 2, BH was higher than 50 MPa in the examples of the present invention under the condition where the content ratio of Mn and Cr was 2.1% or higher, higher than 55 MPa in some of the examples under the condition where the content ratio of Mn and Cr was 2.2% or higher, and 60 MPa or higher in some of the examples under the condition where the content ratio of Mn and Cr was 2.3% or higher. This suggests that BH is favorable as well.

### INDUSTRIAL APPLICABILITY

The galvanized steel sheets according to the present invention are excellent in the strength-ductility balance and BH, and thus can be used as components having high formability and are suitably used in the production of inner and outer panels for automobiles and other applications requiring high formability. Furthermore, inner and outer panels for automobiles using the galvanized steel sheets according to the present invention can be made thinner and lighter than those using known steel sheets.

TABLE 1

| | | | | | | | | | | Mn + | |
|---|---|---|---|---|---|---|---|---|---|---|---|
| | C | Si | Mn | P | S | Sol. Al | N | Cr | Others | 1.29Cr | |
| | (mass | (mass | (mass | (mass | (mass | (mass | (mass | (mass | (mass | (mass | |
| Steel | %) | %) | %) | %) | %) | %) | %) | %) | %) | %) | Remarks |
| A | 0.013 | 0.24 | 1.70 | 0.028 | 0.003 | 0.034 | 0.0036 | 0.40 | — | 2.22 | Composition according to |
| | | | | | | | | | | | the present invention |
| B | 0.027 | 0.03 | 1.90 | 0.011 | 0.008 | 0.038 | 0.0020 | 0.60 | — | 2.67 | Composition according to |
| | | | | | | | | | | | the present invention |
| C | 0.025 | 0.02 | 1.80 | 0.016 | 0.006 | 0.034 | 0.0032 | 0.40 | — | 2.32 | Composition according to |
| | | | | | | | | | | | the present invention |
| D | 0.018 | 0.01 | 2.00 | 0.001 | 0.011 | 0.029 | 0.0029 | 0.30 | — | 2.39 | Composition according to |
| | | | | | | | | | | | the present invention |
| E | 0.031 | 0.28 | 1.50 | 0.030 | 0.009 | 0.048 | 0.0022 | 0.50 | — | 2.15 | Composition according to |
| | | | | | | | | | | | the present invention |
| F | 0.028 | 0.01 | 1.60 | 0.010 | 0.012 | 0.042 | 0.0029 | 0.80 | — | 2.63 | Composition according to |
| | | | | | | | | | | | the present invention |
| G | 0.010 | 0.17 | 1.80 | 0.018 | 0.006 | 0.054 | 0.0055 | 0.25 | — | 2.12 | Composition according to |
| | | | | | | | | | | | the present invention |
| H | 0.029 | 0.05 | 1.90 | 0.065 | 0.009 | 0.021 | 0.0039 | 0.40 | — | 2.42 | Composition according to |
| | | | | | | | | | | | the present invention |
| I | 0.023 | 0.03 | 1.80 | 0.010 | 0.006 | 0.034 | 0.0032 | 0.35 | Mo: 0.2 | 2.25 | Composition according to |
| | | | | | | | | | V: 0.1 | | the present invention |
| J | 0.025 | 0.05 | 1.80 | 0.018 | 0.011 | 0.029 | 0.0029 | 0.60 | Ti: 0.02 | 2.57 | Composition according to |
| | | | | | | | | | Nb: 0.03 | | the present invention |
| K | 0.028 | 0.09 | 1.65 | 0.022 | 0.009 | 0.048 | 0.0022 | 0.40 | B: 0.002 | 2.17 | Composition according to |
| | | | | | | | | | | | the present invention |
| L | 0.019 | 0.01 | 1.65 | 0.031 | 0.012 | 0.042 | 0.0029 | 0.40 | — | 2.17 | Composition according to |
| | | | | | | | | | | | the present invention |
| M | 0.022 | 0.03 | 1.65 | 0.018 | 0.006 | 0.054 | 0.0055 | 0.45 | — | 2.23 | Composition according to |
| | | | | | | | | | | | the present invention |
| N | 0.033 | 0.02 | 1.65 | 0.026 | 0.009 | 0.021 | 0.0039 | 0.65 | — | 2.49 | Composition according to |
| | | | | | | | | | | | the present invention |
| O | 0.038 | 0.21 | 1.65 | 0.032 | 0.007 | 0.032 | 0.0033 | 0.70 | — | 2.55 | Composition according to |
| | | | | | | | | | | | the present invention |
| P | 0.021 | 0.06 | 1.50 | 0.035 | 0.009 | 0.033 | 0.0044 | 0.60 | — | 2.27 | Composition according to |
| | | | | | | | | | | | the present invention |
| Q | 0.016 | 0.03 | 1.50 | 0.020 | 0.009 | 0.041 | 0.0048 | 0.65 | — | 2.34 | Composition according to |
| | | | | | | | | | | | the present invention |
| R | 0.016 | 0.08 | 1.50 | 0.011 | 0.015 | 0.035 | 0.0041 | 0.90 | — | 2.66 | Composition according to |
| | | | | | | | | | | | the present invention |
| S | 0.033 | 0.01 | 1.40 | 0.018 | 0.008 | 0.033 | 0.0028 | 0.75 | — | 2.37 | Composition according to |
| | | | | | | | | | | | the present invention |
| T | 0.002 | 0.02 | 1.60 | 0.020 | 0.005 | 0.0500 | 0.0040 | 0.60 | — | 2.37 | Comparative composition |
| U | 0.046 | 0.21 | 1.80 | 0.037 | 0.015 | 0.044 | 0.0032 | 0.40 | — | 2.32 | Comparative composition |
| V | 0.018 | 0.06 | 1.70 | 0.075 | 0.007 | 0.041 | 0.0013 | 0.20 | — | 1.96 | Comparative composition |
| W | 0.026 | 0.01 | 2.10 | 0.011 | 0.005 | 0.045 | 0.0038 | 0.10 | — | 2.23 | Comparative composition |
| X | 0.017 | 0.25 | 1.50 | 0.075 | 0.009 | 0.039 | 0.0038 | 0.30 | — | 1.89 | Comparative composition |
| Y | 0.033 | 0.05 | 1.80 | 0.011 | 0.028 | 0.057 | 0.0034 | 0.90 | — | 2.96 | Comparative composition |

TABLE 2

| | | | | | | | | | Average | | |
|---|---|---|---|---|---|---|---|---|---|---|---|
| | | Content ratio of a low- | | | | | Primary | Secondary | particle | Volume | Volume fraction |
| | | temperature transformation | Heating | Ac1 | Ac3 | Annealing | cooling | cooling | diameter | fraction of | of a second |
| Sample | | phase in the structure of the | rate* | point | point | temperature | rate | rate | of ferrite | martensite | phase excluding |
| No. | Steel | hot-rolled steel sheet (%) | (° C./s) | (° C.) | (° C.) | (° C.) | (° C./s) | (° C./s) | (μm) | (%) | martensite (%) |
| 1 | A | 100 | 5 | 719 | 875 | 770 | 5 | 8 | 8.7 | 3.5 | 1.2 |
| 2 | A | 100 | 5 | 719 | 875 | 680 | 5 | 8 | 5.7 | 0 | 0 |
| 3 | A | 100 | 5 | 719 | 875 | 890 | 5 | 8 | 15.4 | 1.6 | 2.8 |
| 4 | A | 50 | 5 | 719 | 875 | 770 | 5 | 8 | 8.3 | 3.7 | 1.6 |
| 5 | B | 100 | 5 | 714 | 837 | 770 | 5 | 8 | 8.0 | 8.8 | 0.5 |
| 6 | B | 100 | 5 | 714 | 837 | 840 | 5 | 8 | 9.2 | 2.6 | 2.3 |
| 7 | B | 70 | 5 | 714 | 837 | 770 | 5 | 8 | 8.4 | 8.3 | 0.6 |
| 8 | B | 100 | 5 | 714 | 837 | 820 | 5 | 8 | 8.8 | 9.0 | 0.7 |
| 9 | B | 100 | 20 | 714 | 837 | 770 | 5 | 8 | 7.8 | 8.7 | 0.6 |
| 10 | C | 100 | 5 | 711 | 845 | 770 | 5 | 8 | 7.3 | 6.4 | 0.9 |
| 11 | C | 5 | 5 | 711 | 845 | 770 | 5 | 8 | 7.9 | 6.6 | 1.2 |
| 12 | C | 100 | 20 | 711 | 845 | 770 | 5 | 8 | 6.8 | 6.5 | 1.1 |
| 13 | D | 100 | 5 | 707 | 832 | 770 | 5 | 8 | 8.2 | 5.0 | 1.2 |
| 14 | D | 100 | 5 | 707 | 832 | 860 | 5 | 8 | 10.9 | 1.9 | 2.6 |
| 15 | E | 100 | 5 | 724 | 876 | 770 | 5 | 8 | 7.7 | 7.1 | 1.9 |
| 16 | E | 100 | 5 | 724 | 876 | 700 | 5 | 8 | 8.3 | 0 | 0 |
| 17 | F | 100 | 5 | 720 | 843 | 770 | 5 | 8 | 10.5 | 7.4 | 0.5 |
| 18 | G | 100 | 5 | 713 | 875 | 770 | 5 | 8 | 8.5 | 3.9 | 1.6 |
| 19 | H | 100 | 5 | 711 | 870 | 770 | 5 | 8 | 7.4 | 7.6 | 0.7 |
| 20 | I | 100 | 5 | 711 | 860 | 740 | 5 | 8 | 7.5 | 4.7 | 1.1 |
| 21 | J | 100 | 5 | 715 | 858 | 750 | 5 | 8 | 6.9 | 7.4 | 0.6 |
| 22 | K | 100 | 5 | 715 | 869 | 800 | 5 | 8 | 13 | 4.2 | 1.7 |
| 23 | L | 100 | 5 | 712 | 867 | 790 | 5 | 8 | 12.3 | 4.0 | 1.6 |
| 24 | M | 100 | 5 | 714 | 861 | 780 | 5 | 8 | 11.3 | 4.6 | 1.1 |
| 25 | N | 100 | 5 | 717 | 844 | 780 | 5 | 8 | 10.9 | 6.7 | 0.7 |
| 26 | N | 80 | 5 | 717 | 844 | 800 | 5 | 8 | 11.5 | 6.9 | 0.7 |
| 27 | N | 30 | 5 | 717 | 844 | 790 | 5 | 8 | 10.4 | 6.5 | 1.1 |
| 28 | N | 100 | 5 | 717 | 844 | 760 | 5 | 4 | 10.2 | 6.3 | 1.1 |
| 29 | N | 100 | 5 | 717 | 844 | 800 | 5 | 20 | 11.3 | 7.0 | 0.5 |
| 30 | O | 100 | 5 | 723 | 858 | 810 | 5 | 8 | 11.7 | 7.2 | 0.6 |
| 31 | P | 100 | 5 | 719 | 869 | 770 | 5 | 8 | 7.5 | 4.9 | 1.1 |
| 32 | Q | 100 | 5 | 719 | 864 | 750 | 5 | 8 | 7.3 | 5.5 | 0.8 |
| 33 | Q | 100 | 5 | 719 | 864 | 750 | 3 | 8 | 7.3 | 5.4 | 1.3 |
| 34 | Q | 100 | 5 | 719 | 864 | 780 | 20 | 8 | 7.6 | 5.8 | 0.5 |
| 35 | Q | 100 | 5 | 719 | 864 | 850 | 5 | 8 | 7.8 | 5.8 | 1.0 |
| 36 | Q | 100 | 5 | 719 | 864 | 880 | 5 | 8 | 8.4 | 1.5 | 2.5 |
| 37 | R | 100 | 5 | 724 | 855 | 740 | 5 | 8 | 6.8 | 8.1 | 0.5 |
| 38 | S | 100 | 5 | 721 | 849 | 750 | 5 | 8 | 7.2 | 5.7 | 0.8 |
| 39 | T | 100 | 5 | 717 | 881 | 770 | 5 | 8 | 13.1 | 0 | — |
| 40 | U | 100 | 5 | 717 | 861 | 770 | 5 | 8 | 7.4 | 11.6 | 2.3 |
| 41 | V | 100 | 5 | 710 | 901 | 770 | 5 | 8 | 7.9 | 2.5 | 2.8 |
| 42 | W | 100 | 5 | 703 | 839 | 770 | 5 | 8 | 7.5 | 4.7 | 2.1 |
| 43 | X | 100 | 5 | 719 | 915 | 770 | 5 | 8 | 8.1 | 2.3 | 2.7 |
| 44 | Y | 100 | 5 | 720 | 842 | 770 | 5 | 8 | 7.8 | 10.7 | 0.4 |

| | Percentage of | | | | | | | | |
|---|---|---|---|---|---|---|---|---|---|
| | martensite | | | | | | | | |
| | crystallizing in | | | | | | | | |
| Sample | the grain | YP | TS | T-EI | U-EI | L-EI | TS × EI | BH | |
| No. | boundary (%) | (MPa) | (MPa) | (%) | (%) | (%) | (MPa · %) | (MPa) | Remarks |
| 1 | 95 | 227 | 419 | 39.7 | 22.8 | 16.9 | 16634 | 57 | Example of the |
| | | | | | | | | | present invention |
| 2 | — | 282 | 380 | 40.0 | 21.4 | 18.6 | 15200 | 22 | Comparative Example |
| 3 | 78 | 236 | 409 | 38.4 | 21.8 | 16.6 | 15720 | 34 | Comparative Example |
| 4 | 95 | 231 | 414 | 39.0 | 22.8 | 16.2 | 16146 | 54 | Example of the |
| | | | | | | | | | present invention |
| 5 | 94 | 267 | 507 | 32.1 | 20.0 | 12.1 | 16275 | 66 | Example of the |
| | | | | | | | | | present invention |
| 6 | 81 | 292 | 479 | 31.9 | 19.9 | 12.0 | 15280 | 41 | Comparative Example |
| 7 | 93 | 265 | 509 | 31.9 | 19.9 | 12.0 | 16237 | 67 | Example of the |
| | | | | | | | | | present invention |
| 8 | 94 | 270 | 510 | 31.4 | 19.4 | 12.0 | 16030 | 66 | Example of the |
| | | | | | | | | | present invention |
| 9 | 91 | 266 | 505 | 31.8 | 19.7 | 12.1 | 16050 | 64 | Example of the |
| | | | | | | | | | present invention |
| 10 | 98 | 224 | 458 | 37.6 | 22.2 | 15.4 | 17221 | 61 | Example of the |
| | | | | | | | | | present invention |
| 11 | 97 | 227 | 450 | 36.8 | 22.2 | 14.6 | 16560 | 61 | Example of the |
| | | | | | | | | | present invention |
| 12 | 95 | 226 | 460 | 36.7 | 22.2 | 14.5 | 16900 | 60 | Example of the |
| | | | | | | | | | present invention |
| 13 | 97 | 239 | 466 | 35.5 | 21.5 | 14.0 | 16543 | 62 | Example of the |
| | | | | | | | | | present invention |
| 14 | 84 | 274 | 457 | 34.3 | 20.5 | 13.8 | 15675 | 38 | Comparative Example |
| 15 | 94 | 237 | 474 | 33.8 | 20.7 | 13.1 | 16021 | 51 | Example of the |
| | | | | | | | | | present invention |
| 16 | — | 283 | 415 | 38.5 | 24.1 | 14.4 | 15978 | 23 | Comparative Example |
| 17 | 92 | 262 | 478 | 34.3 | 20.5 | 13.8 | 16395 | 66 | Example of the |
| | | | | | | | | | present invention |
| 18 | 91 | 226 | 422 | 38.5 | 22.3 | 16.2 | 16247 | 52 | Example of the |
| | | | | | | | | | present invention |
| 19 | 97 | 238 | 485 | 35.6 | 21.5 | 14.1 | 17266 | 62 | Example of the |
| | | | | | | | | | present invention |
| 20 | 93 | 245 | 444 | 38.0 | 21.8 | 16.2 | 16850 | 56 | Example of the |
| | | | | | | | | | present invention |
| 21 | 98 | 248 | 478 | 35.8 | 22.3 | 13.5 | 17120 | 65 | Example of the |
| | | | | | | | | | present invention |
| 22 | 92 | 211 | 438 | 37.3 | 23.1 | 14.2 | 16320 | 53 | Example of the |
| | | | | | | | | | present invention |
| 23 | 93 | 216 | 435 | 37.7 | 23.3 | 14.4 | 16400 | 51 | Example of the |
| | | | | | | | | | present invention |
| 24 | 94 | 222 | 441 | 38.1 | 23.8 | 14.3 | 16840 | 56 | Example of the |
| | | | | | | | | | present invention |
| 25 | 98 | 255 | 469 | 37.3 | 22.8 | 14.5 | 17500 | 64 | Example of the |
| | | | | | | | | | present invention |
| 26 | 98 | 252 | 466 | 37.6 | 22.9 | 14.7 | 17540 | 62 | Example of the |
| | | | | | | | | | present invention |
| 27 | 98 | 258 | 471 | 35.7 | 22.2 | 13.5 | 16800 | 62 | Example of the |
| | | | | | | | | | present invention |
| 28 | 97 | 258 | 469 | 36.0 | 22.6 | 13.4 | 16900 | 63 | Example of the |
| | | | | | | | | | present invention |
| 29 | 98 | 249 | 460 | 38.5 | 23.6 | 14.9 | 17700 | 65 | Example of the |
| | | | | | | | | | present invention |
| 30 | 99 | 255 | 476 | 36.0 | 21.4 | 14.6 | 17100 | 63 | Example of the |
| | | | | | | | | | present invention |
| 31 | 94 | 232 | 446 | 38.0 | 22.9 | 15.1 | 16950 | 57 | Example of the |
| | | | | | | | | | present invention |
| 32 | 97 | 228 | 453 | 37.8 | 23.5 | 14.2 | 17100 | 63 | Example of the |
| | | | | | | | | | present invention |
| 33 | 98 | 228 | 455 | 37.1 | 23.2 | 13.9 | 16120 | 61 | Example of the |
| | | | | | | | | | present invention |
| 34 | 94 | 224 | 449 | 37.6 | 23.3 | 14.3 | 16880 | 61 | Example of the |
| | | | | | | | | | present invention |
| 35 | 95 | 238 | 455 | 36.7 | 23.0 | 13.7 | 16680 | 62 | Example of the |
| | | | | | | | | | present invention |
| 36 | 82 | 277 | 446 | 35.6 | 22.5 | 13.1 | 15860 | 45 | Comparative Example |
| 37 | 93 | 260 | 487 | 33.3 | 19.6 | 13.6 | 16200 | 64 | Example of the |
| | | | | | | | | | present invention |
| 38 | 98 | 232 | 456 | 37.7 | 22.8 | 14.9 | 17200 | 61 | Example of the |
| | | | | | | | | | present invention |
| 39 | — | 236 | 346 | 42.9 | 24.1 | 18.8 | 14843 | 10 | Comparative Example |
| 40 | 96 | 303 | 577 | 27.4 | 16.6 | 10.8 | 15810 | 63 | Comparative Example |
| 41 | 97 | 271 | 401 | 39.7 | 23.0 | 16.7 | 15920 | 45 | Comparative Example |
| 42 | 86 | 235 | 463 | 33.9 | 20.3 | 13.6 | 15696 | 55 | Comparative Example |
| 43 | 99 | 288 | 406 | 39.2 | 22.7 | 16.5 | 15915 | 39 | Comparative Example |
| 44 | 91 | 281 | 492 | 31.3 | 20.4 | 10.9 | 15400 | 63 | Comparative Example |

*Heating rate for heating from Ac1 transformation point, −50° C., to a constant annealing temperature

1. A galvanized steel sheet, comprising C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.1 to 2.8, and further comprising iron and unavoidable impurities as the balance, wherein the structure of the galvanized steel sheet consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

2. A galvanized steel sheet, comprising C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.2 to 2.8, and further comprising iron and unavoidable impurities as the balance, wherein the structure of the galvanized steel sheet consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

3. A galvanized steel sheet, comprising C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.2 to 1.0%, respectively, with Mn (mass %)+1.29Cr (mass %) being in the range of 2.3 to 2.8, and further comprising iron and unavoidable impurities as the balance, wherein the structure of the galvanized steel sheet consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

4. A galvanized steel sheet, comprising C, Si, Mn, P, S, Al, N and Cr at content ratios in mass % of 0.005 to 0.04%, 1.5% or lower, 1.0 to 2.0%, 0.10% or lower, 0.03% or lower, 0.01 to 0.1%, less than 0.008% and 0.35 to 0.8%, respectively, with Mn (mass %)+1.29Cr (mass %) being in the range of 2.3 to 2.8, and further comprising iron and unavoidable impurities as the balance, wherein the structure of the galvanized steel sheet consists of a ferrite phase and a martensite phase with a volume fraction being at least 3.0% and less than 10%, the average particle diameter of the ferrite is larger than 6 μm and not more than 15 μm, and 90% or more of the martensite phase exists in a ferrite grain boundary.

5. The galvanized steel sheet according to claim 1, further comprising one or more of Mo, V, B, Ti and Nb at content ratios in mass % of 0.5% or lower, 0.5% or lower, 0.01% or lower, 0.1% or lower and 0.1% or lower, respectively.

6. The galvanized steel sheet according to claim 1, wherein zinc used to plate the steel sheet is alloyed.

7. A method for producing a galvanized steel sheet, comprising a step of melting steel having the chemical composition described in claim 1, subsequent hot and cold rolling steps, and a step of annealing the obtained steel sheet at an annealing temperature being at least the Ac1 point and not more than the Ac3 point.

8. A method for producing a galvanized steel sheet, comprising a cold rolling step for rolling a hot-rolled steel sheet that has the chemical composition described in claim 1 and further contains a low-temperature transformation phase at a volume fraction of 60% or higher, and a step of annealing the obtained steel sheet at an annealing temperature being at least the Ac1 point and not more than the Ac3 point.

9. The method for producing a galvanized steel sheet according to claim 7, wherein zinc used to plate the steel sheet is alloyed after galvanization.

10. The galvanized steel sheet according to claim 2, further comprising one or more of Mo, V, B, Ti and Nb at content ratios in mass % of 0.5% or lower, 0.5% or lower, 0.01% or lower, 0.1% or lower and 0.1% or lower, respectively.

11. The galvanized steel sheet according to claim 3, further comprising one or more of Mo, V, B, Ti and Nb at content ratios in mass % of 0.5% or lower, 0.5% or lower, 0.01% or lower, 0.1% or lower and 0.1% or lower, respectively.

12. The galvanized steel sheet according to claim 4, further comprising one or more of Mo, V, B, Ti and Nb at content ratios in mass % of 0.5% or lower, 0.5% or lower, 0.01% or lower, 0.1% or lower and 0.1% or lower, respectively.

13. The galvanized steel sheet according to claim 2, wherein zinc used to plate the steel sheet is alloyed.

14. The galvanized steel sheet according to claim 3, wherein zinc used to plate the steel sheet is alloyed.

15. The galvanized steel sheet according to claim 4, wherein zinc used to plate the steel sheet is alloyed.

16. The galvanized steel sheet according to claim 5, wherein zinc used to plate the steel sheet is alloyed.

17. The galvanized steel sheet according to claim 10, wherein zinc used to plate the steel sheet is alloyed.

18. The galvanized steel sheet according to claim 11, wherein zinc used to plate the steel sheet is alloyed.

19. The galvanized steel sheet according to claim 12, wherein zinc used to plate the steel sheet is alloyed.

20. A method for producing a galvanized steel sheet, comprising a step of melting steel having the chemical composition described in claim 2, subsequent hot and cold rolling steps, and a step of annealing the obtained steel sheet at an annealing temperature being at least the Ac1 point and not more than the Ac3 point.

21. A method for producing a galvanized steel sheet, comprising a step of melting steel having the chemical composition described in claim 3, subsequent hot and cold rolling steps, and a step of annealing the obtained steel sheet at an annealing temperature being at least the Ac1 point and not more than the Ac3 point.

22. A method for producing a galvanized steel sheet, comprising a step of melting steel having the chemical composition described in claim 4, subsequent hot and cold rolling steps, and a step of annealing the obtained steel sheet at an annealing temperature being at least the Ac1 point and not more than the Ac3 point.

23. A method for producing a galvanized steel sheet, comprising a step of melting steel having the chemical composition described in claim 5, subsequent hot and cold rolling steps, and a step of annealing the obtained steel sheet at an annealing temperature being at least the Ac1 point and not more than the Ac3 point.

24. A method for producing a galvanized steel sheet, comprising a step of melting steel having the chemical composition described in claim 10, subsequent hot and cold rolling steps, and a step of annealing the obtained steel sheet at an annealing temperature being at least the Ac1 point and not more than the Ac3 point.

25. A method for producing a galvanized steel sheet, comprising a step of melting steel having the chemical composition described in claim 11, subsequent hot and cold rolling steps, and a step of annealing the obtained steel sheet at an annealing temperature being at least the Ac1 point and not more than the Ac3 point.

26. A method for producing a galvanized steel sheet, comprising a step of melting steel having the chemical composition described in claim 12, subsequent hot and cold rolling steps, and a step of annealing the obtained steel sheet at an annealing temperature being at least the Ac1 point and not more than the Ac3 point.

27. A method for producing a galvanized steel sheet, comprising a cold rolling step for rolling a hot-rolled steel sheet that has the chemical composition described in claim 2 and further contains a low-temperature transformation phase at a volume fraction of 60% or higher, and a step of annealing the obtained steel sheet at an annealing temperature being at least the Ac1 point and not more than the Ac3 point.

28. A method for producing a galvanized steel sheet, comprising a cold rolling step for rolling a hot-rolled steel sheet that has the chemical composition described in claim 3 and further contains a low-temperature transformation phase at a volume fraction of 60% or higher, and a step of annealing the obtained steel sheet at an annealing temperature being at least the Ac1 point and not more than the Ac3 point.

29. A method for producing a galvanized steel sheet, comprising a cold rolling step for rolling a hot-rolled steel sheet that has the chemical composition described in claim 4 and further contains a low-temperature transformation phase at a volume fraction of 60% or higher, and a step of annealing the obtained steel sheet at an annealing temperature being at least the Ac1 point and not more than the Ac3 point.

30. A method for producing a galvanized steel sheet, comprising a cold rolling step for rolling a hot-rolled steel sheet that has the chemical composition described in claim 5 and further contains a low-temperature transformation phase at a volume fraction of 60% or higher, and a step of annealing the obtained steel sheet at an annealing temperature being at least the Ac1 point and not more than the Ac3 point.

31. A method for producing a galvanized steel sheet, comprising a cold rolling step for rolling a hot-rolled steel sheet that has the chemical composition described in claim 10 and further contains a low-temperature transformation phase at a volume fraction of 60% or higher, and a step of annealing the obtained steel sheet at an annealing temperature being at least the Ac1 point and not more than the Ac3 point.

32. A method for producing a galvanized steel sheet, comprising a cold rolling step for rolling a hot-rolled steel sheet that has the chemical composition described in claim 11 and further contains a low-temperature transformation phase at a volume fraction of 60% or higher, and a step of annealing the obtained steel sheet at an annealing temperature being at least the Ac1 point and not more than the Ac3 point.

33. A method for producing a galvanized steel sheet, comprising a cold rolling step for rolling a hot-rolled steel sheet that has the chemical composition described in claim 12 and further contains a low-temperature transformation phase at a volume fraction of 60% or higher, and a step of annealing the obtained steel sheet at an annealing temperature being at least the Ac1 point and not more than the Ac3 point.

34. The method for producing a galvanized steel sheet according to claim 20, wherein zinc used to plate the steel sheet is alloyed after galvanization.

35. The method for producing a galvanized steel sheet according to claim 21, wherein zinc used to plate the steel sheet is alloyed after galvanization.

36. The method for producing a galvanized steel sheet according to claim 22, wherein zinc used to plate the steel sheet is alloyed after galvanization.

37. The method for producing a galvanized steel sheet according to claim 23, wherein zinc used to plate the steel sheet is alloyed after galvanization.

38. The method for producing a galvanized steel sheet according to claim 24, wherein zinc used to plate the steel sheet is alloyed after galvanization.

39. The method for producing a galvanized steel sheet according to claim 25, wherein zinc used to plate the steel sheet is alloyed after galvanization.

40. The method for producing a galvanized steel sheet according to claim 26, wherein zinc used to plate the steel sheet is alloyed after galvanization.

41. The method for producing a galvanized steel sheet according to claim 8, wherein zinc used to plate the steel sheet is alloyed after galvanization.

42. The method for producing a galvanized steel sheet according to claim 27, wherein zinc used to plate the steel sheet is alloyed after galvanization.

43. The method for producing a galvanized steel sheet according to claim 28, wherein zinc used to plate the steel sheet is alloyed after galvanization.

44. The method for producing a galvanized steel sheet according to claim 29, wherein zinc used to plate the steel sheet is alloyed after galvanization.

45. The method for producing a galvanized steel sheet according to claim 30, wherein zinc used to plate the steel sheet is alloyed after galvanization.

46. The method for producing a galvanized steel sheet according to claim 31, wherein zinc used to plate the steel sheet is alloyed after galvanization.

47. The method for producing a galvanized steel sheet according to claim 32, wherein zinc used to plate the steel sheet is alloyed after galvanization.

48. The method for producing a galvanized steel sheet according to claim 33, wherein zinc used to plate the steel sheet is alloyed after galvanization.
